(19) United States
(12) Patent Application Publication
(10) Pub. No.: US 2005/0226134 A1
(43) Pub. Date: Oct. 13, 2005

(54) Track forming method for optical recording medium, and information recording method

(76) Inventor: Harukazu Miyamoto, Higashimurayama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/099,656

(22) Filed: Apr. 6, 2005

(30) Foreign Application Priority Data
Apr. 7, 2004 (JP) 2004-112654

(51) Int. Cl. G11B 7/24

(52) U.S. Cl. 369/275.3

(57) ABSTRACT

The increase in manufacturing cost that would result if a tracking pattern is transferred to all of the layers of a multilayered recording medium is prevented. A servo pattern is formed in a part of the medium in advance, and then servo patterns are additionally formed with one of two optical spots while performing a tracking using the other optical spot. Prewriting of the media prior to shipping can be performed in a short time, so that the manufacturing cost of the media can be significantly reduced.

### CLAIM OF PRIORITY

The present application claims priority from Japanese application JP 2004-112654 filed on Apr. 7, 2004, the content of which is hereby incorporated by reference into this application.

### BACKGROUND OF THE INVENTION

1. Field of Invention

The invention relates to a track forming method for forming a substantially spiral information track on an disc-shaped information recording medium, and a information recording method for recording information on an information recording medium.

2. Related Art

Various methods for forming tracks on an optical disc have been proposed, such as those disclosed in JP Patent Publication (Kokai) No. 60-50733 A (1985) and JP Patent Publication (Kokai) No. 61-13458 A (1986), for example. In these known examples, the light emitted by a laser light source 1 is separated by a beam splitter 2 into guide groove recording light 100 and header recording light 200, as shown in FIG. 4. These beams of light are composed after being intensity-modulated in accordance with relevant signals by optical modulators 4 and 3 driven by signals G and H, respectively, sent from a signal source 15. The composed beam of light irradiates a photosensitive layer 13 formed on a disc 12 via a lens 9 and a recording lens 10 so as to record the signals on the photosensitive layer. In order to form a header signal between guide grooves, guide groove recording light 100 is tilted by mirrors 8 and 8′ by a required angle such that the guide groove recording light 100 is incident on the lens 9 at an angle with respect to the header recording light.
Patent Document 1: JP Patent Publication (Kokai) No. 60-50733 A (1985)
Patent Document 2: JP Patent Publication (Kokai) No. 61-13458 A (1986)
Patent Document 3: JP Patent Publication (Kokai) No. 63-308745 A (1988)

### SUMMARY OF THE INVENTION

In the aforementioned track forming method, a spindle 14 is moved by a distance corresponding to the track pitch before the disc makes a complete rotation. In order to obtain a uniform track pitch, it is necessary to control the amount of movement in a continuous (smooth) and highly accurate manner. For this purpose, a dedicated master manufacturing machine with a highly accurate feed capability has been employed. Such a machine, however, is very expensive. Therefore, the tracks formed by the aforementioned method are typically transferred to a plastic substrate, for example, by injection molding or the 2P process. However, injection molding requires a substrate with a thickness of 0.1 mm or more, with the result that when substrates formed by injection molding are stacked into a multilayered laminate, the thickness of the laminate becomes too large. Furthermore, the 2P process requires performing the transfer of the tracks for individual layers, resulting in an increase in manufacturing cost. It is also difficult to achieve a high positioning accuracy.

Another technique is disclosed in JP Patent Publication (Kokai) No. 63-308745 A (1988) whereby, after the recording grooves are formed, a photosensitive agent is reapplied, and then the grooves are further processed while performing a tracking with reference to the initially formed grooves. In this method, the required accuracy is not so high because the cutting is performed while tracking the initially formed grooves during the second processing. However, this is after all a technique whereby the initially recorded regions are further processed into more complex shapes, so that it does not help reduce the labor and cost involved in the initial processing (cutting).

Namely, this technique also involves the transfer of the tracks onto a plastic substrate or the like by injection molding or the 2P process, as in the earlier example, and it does not solve the aforementioned problems of the prior art.

Referring to FIG. 3, an example of a conventional optical recording system for recording and reproducing an optical disc with tracks formed by the conventional method will be described.

FIG. 3 shows a block diagram of a conventional optical recording and reproducing apparatus. A laser light source 25 (with the wavelength of approx. 660 nm in the case of DVD-RAM), which forms a part of a head 19, emits light. The light is collimated into substantially parallel optical beams 22 by a collimating lens 24. The optical beams 22 irradiate an optical disc 18 via an objective lens 23, forming a spot 21. Thereafter, the beams are guided to a servo detector 26 and a signal detector 27 via a beam splitter 28 and a hologram element 29, for example. The signals from each detector are summed or subtracted to produce servo signals, such as a tracking error signal and a focus error signal, which are then inputted to a servo circuit. The servo circuit, using the obtained tracking error signal and focus error signal, controls a drive means 31 for the objective lens 23 or the position of the entire optical head 2 such that the optical spot 21 can be positioned at a target recording or reproducing region. A sum signal from the detector 27 is fed to a signal reproduction block 41. The input signal is filtered and frequency-equalized by a signal processing circuit and is then digitally processed. The digital signal is then processed by an address detection circuit and a demodulation circuit. Based on an address signal detected by the address detection circuit, a microprocessor calculates the position of the optical spot 21 on the optical disc 18 and then controls an automatic position control means, such that the optical head 2 and the optical spot 21 are positioned at a target recording unit region (sector).

In the case where a higher-level device directs the optical recording and reproducing apparatus to record, the microprocessor receives recording data from the higher-level device and stores it in a memory, while controlling the automatic position control means to position the optical spot 21 at a target recording region. The microprocessor, after confirming that the optical spot 21 has correctly been positioned at the recording region based on the address signal from the signal reproduction block 41, controls a laser driver, for example, to record the stored data in the target recording region.

As described above, in accordance with the conventional cutting method, the manufacturing cost increases if the recording layers are to be multilayered for greater capacities, and it is difficult to reduce the eccentricity among the layers due to their relative positioning errors.

It is an object of the invention to provide a track manufacturing method capable of forming a tracking groove or mark with hardly any increase in cost when the number of recording layers is five or more.

In order to achieve the aforementioned object, the invention provides the following means.
(1) A disc-shaped optical recording medium is irradiated at least with a first optical spot and a second optical spot, and a tracking mark or a guide groove is formed using said second spot while performing a tracking using said first optical spot. In this way, tracks can be formed accurately using the second spot while using the first spot as a guide. Thus, it becomes possible to manufacture media with narrow-pitched tracks without requiring a highly accurate cutting device as in the conventional, thereby reducing manufacturing cost.

This feature is particularly advantageous in the case of multilayered media, as it reduces the eccentricity between layers. Although the above means makes reference to the formation of tracks, the step of forming tracks may comprise the recording of information if the track formation and the recording mark formation are performed in the same step, as in the cases of the pits in ROMs or write-once media, for example.
(2) The same recording surface is irradiated with said first optical spot and said second optical spot, and the distance between the first spot and said second spot in the radial direction is substantially equal to an integer multiple or ½ of an integer multiple of the track pitch. In this way, a spiral track can be formed continuously.
(3) A tracking mark or guide groove is formed on a recording surface of the medium in advance, making at least one complete rotation. The optical recording medium comprises a plurality of recording surfaces, and different recording surfaces are irradiated with said first optical spot and said second optical spot. In this way, the medium can be shipped after recording it with only the initial, complete-circled track, so that the media manufacturing cost can be significantly reduced.
(4) A tracking mark or a guide groove is formed in advance on only one of the multiple recording surfaces.

In this way, the need to form the guide groove in all of the layers in a multilayered medium in advance can be eliminated, thereby reducing the media manufacturing cost.
(5) Address data or user data is recorded simultaneously with the formation of the tracking mark or guide groove.
(6) A track forming method for a disc-shaped optical information recording medium, comprising forming a spiral or concentric track making at least one complete rotation, and then forming the remaining tracks using the earlier-formed track for tracking purposes. In this way, the optical disc manufacturing cost can be significantly reduced.

Although the aforementioned means involve the formation of two spots, tracks can be easily formed using a conventional apparatus.

In accordance with the invention, prewriting of the media prior to shipping can be performed in a short time, so that the media manufacturing cost can be significantly reduced.

### BRIEF DESCRIPTION OF THE DRAWINGS

FIG. 1 shows the principle of forming a track in an embodiment of the invention.

FIG. 2 shows a recording medium in an embodiment of the invention.

FIG. 3 shows an example of a conventional recording apparatus.

FIG. 4 shows an example of a conventional disc manufacturing apparatus.

FIG. 5 shows the principle of another embodiment of the invention.

FIG. 6 shows a block diagram of an apparatus according to an embodiment of the invention.

FIG. 7 shows the shapes of tracks in examples of the invention.

FIG. 8 shows an example of an optical head in an embodiment of the invention.

### DESCRIPTION OF THE PREFERRED EMBODIMENTS

### Embodiment 1

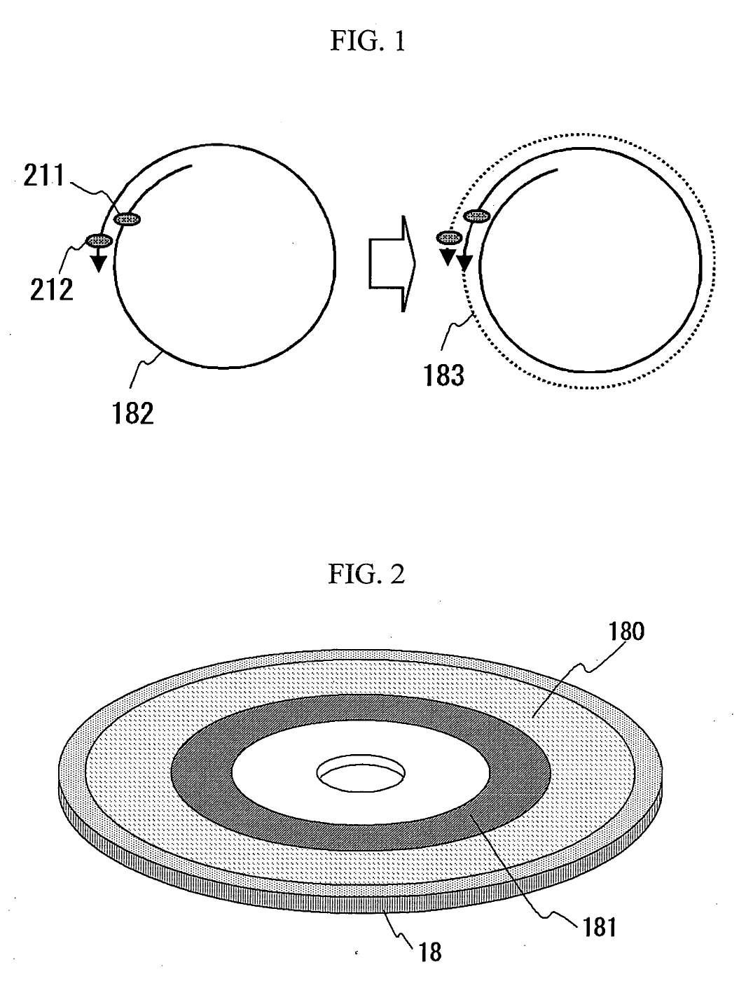

FIG. 1 (left) shows an initially prewritten track 182 formed on a disc. The track may be formed by a variety of ways, as descried in the subsequent embodiments. The following description is based on the assumption that there is the prewritten track on the disc. The track 182 that has been prewritten is tracked using a first optical spot 211 so that the first optical spot 211 and a second optical spot 212 can be disposed on the track 182. When the radial distance between the first and the second optical spots is equal to the track pitch, which is approximately 0.32 μm in the present embodiment, the second spot would be automatically disposed on the prewritten track 182. As the disc rotates, the optical spots 211 and 212 move relative to the disc in the direction indicated by the arrow, and the second spot 182 comes to a region where no tracks are formed. By irradiating the medium with a light beam with an intensity such that a recording mark can be formed on the medium, a track 181 is additionally formed. By repeating this process, tracks can be formed sequentially up to the periphery of the disc.

FIG. 2 shows an optical disc 18 with an inner region 181 where tracks are formed and a peripheral region 180 where no tracks are formed.

Although in the present embodiment it is assumed that the disc is recorded from the inner side thereof sequentially, the same effect would be obtained when recorded from the peripheral side. In the latter case, the first optical spot would be disposed towards the radially peripheral side of the disc. The radial distance between the first and second optical spots is equal to the track pitch, or 0.32 μm. The circumferential distance between them, which is not so important, is typically on the order of 10 μm so that they can be sufficiently resolved on a detector.

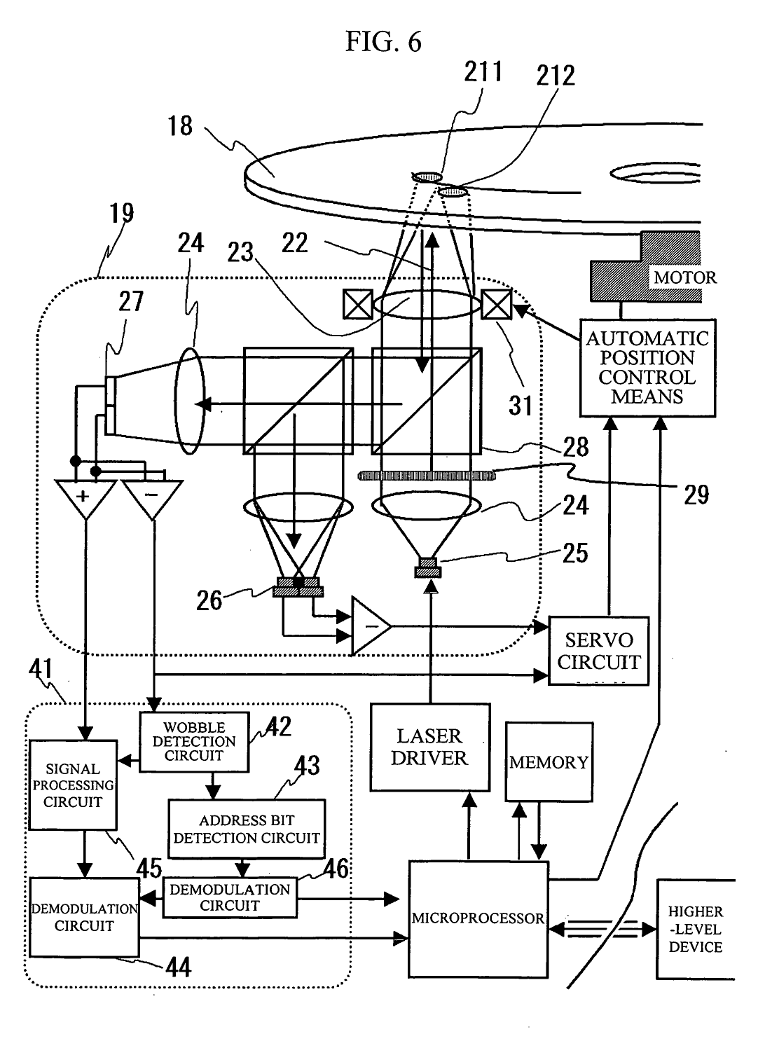

FIG. 6 shows a block diagram of an embodiment of an optical recording apparatus adapted to the invention. A laser light source 25 (with the wavelength of approx. 405 nm in the present embodiment), which forms a part of a head 19, emits light that is collimated into substantially parallel optical beams 22 by a collimating lens 24. The beams of the first-order diffracted light are then slightly deflected by a blazed diffraction grating 29. Thereafter, the optical beams 22 irradiate the optical disc 18 via an objective lens 23, thereby forming two spots on the optical disc 18. The ratio of intensity of the first optical spot 211 and the second optical spot 212 was adjusted to be approximately 1:10. This ensures that the intensity of the first spot is sufficiently small when recording with the second spot, thus preventing the destruction of the tracks that have been previously formed. Thus, the intensity of the second spot is preferably smaller than that of the first spot. Reflected light from the two optical spots is guided to a servo detector 26 and a signal detector 27 or the like via a beam splitter 28, for example. Although not shown in the drawing, there are actually two sets of the servo detector 26 and signal detector 27, one set detecting information in the reflected light from the first optical spot and the other from the second optical spot.

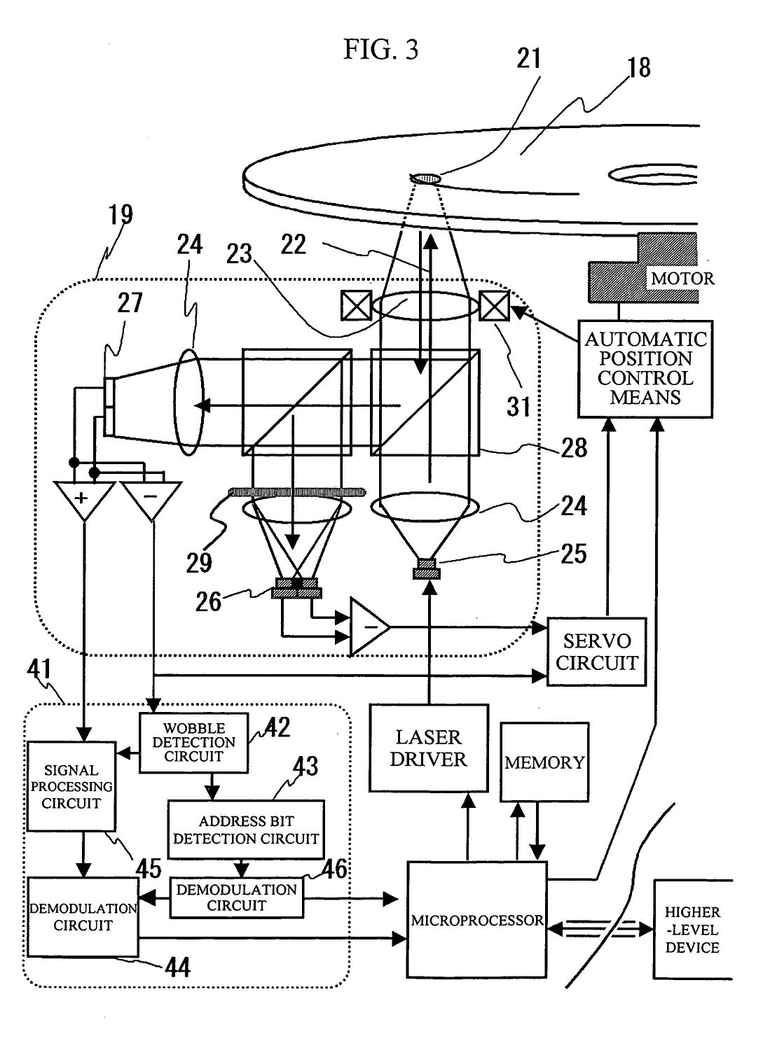

Immediately prior to recording, namely, in the state shown to the left of FIG. 1, the servo signal is derived from a signal detected from the first optical spot, while a read signal is derived from a signal obtained from the second optical spot, so that the data that is recorded using the second spot can be timed with the immediately preceding data. Once the recording starts, the signal detector 27 is switched to the first optical spot. In this way, the information in the immediately prior track (one track earlier) can be read, and it can be confirmed continuously that the recording is taking place correctly and that the right track is being recorded. Thus, a highly reliable recording can be performed. Should the immediately earlier track be unable to be normally read due to fingerprints or a scratch on the disc surface, the recording apparatus shown in FIG. 3 reports it to the higher-level device as a recording error. If it turns out, based on the immediately subsequent reading, that reading is possible but the recording power is rather lacking, for example, the recording power is corrected. This means that a real-time power control can be made using the immediately subsequent optical spot. In the illustrated example, however, because the first and second optical spots utilize the light emitted by the same laser 25, the second optical spot is modulated in one way or another during recording. Therefore, detection of the address information would become easier if it is superposed on the data signal as a low-frequency component. It goes without saying that the reliability would be further improved by simultaneously recording the address signal as normal data.

The servo detector detects the servo signal obtained from the first optical spot. Signals from the individual detectors are summed or subtracted to produce servo signals, such as a tracking error signal and a focus error signal, which are then fed to a servo circuit. The servo circuit, using the tracking error signal and focus error signal, controls a drive means 31 for the objective lens 23 and the position of the entire optical head 2, such that the first optical spot 211 can be positioned at the target recording or reproducing region. A sum signal from the detectors 27 is fed to a signal reproducing block 41. The thus input signal is filtered, frequency-equalized, and then digitalized by a signal processing circuit. The digitally processed signal is further processed by an address detection circuit and a demodulation circuit. Using the address signal detected by the address detection circuit, the microprocessor calculates the position of the optical spot 21 on the optical disc 19 and controls an automatic position control means such that the optical head 2 and the optical spot 21 can be positioned at the target recording unit region (sector).

In the case where the instruction from the higher-level device to the optical recording and reproducing apparatus is that for recording, the microprocessor receives recording data from the higher-level device and stores it in memory, while controlling the automatic position control means such that the optical spot 21 can be positioned at the target recording region. The microprocessor, after confirming from the address signal from the signal reproducing block 41 that the optical spot 21 has correctly been positioned at the recording region, controls the laser driver or the like, thereby recording the stored data in the target recording region.

### Embodiment 2

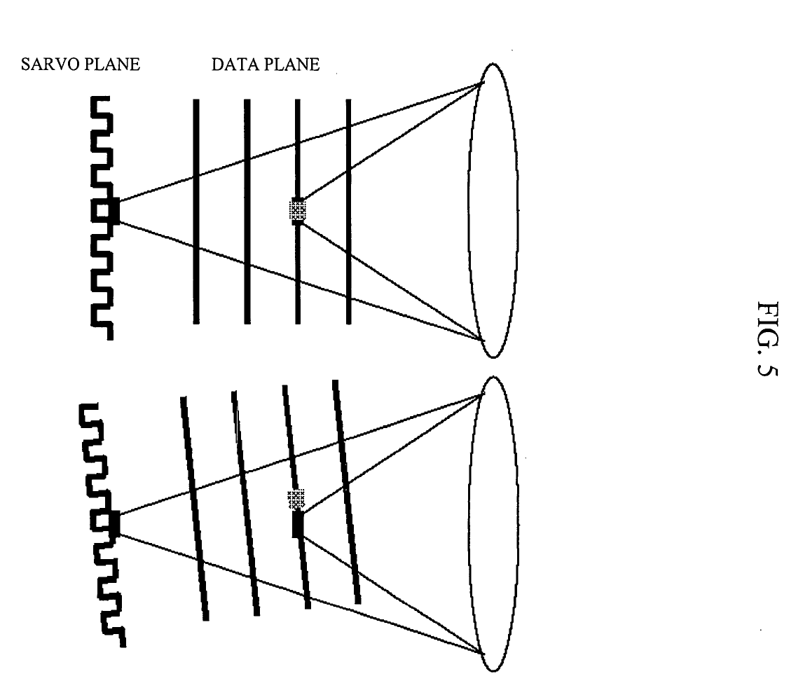

FIG. 5 shows the arrangement of the optical spots in another embodiment of the invention. In this embodiment, the optical recording medium is a multilayered recording medium. In this case, a pre-pit or a pre-groove is formed with an irregular pattern or the like in one of the layers of the multilayered recording surface, in the form of a (initial) servo plane. The first spot is focused on the servo plane for tracking, while the second spot is focused on another plane. At this point in time, the servo plane is used for tracking. Then, the information recorded on the plane opposite to that for the reading is tracked. Tracking is performed based on the information in the tracks formed on the plane because the information on the servo plane and that on the data plane might be displaced should the disc be tilted, for example, as shown in the right hand side of FIG. 5. In consideration of the possibility that the disc could be warped by heat, for example, during recording, the present method is preferably combined with the method of Embodiment 1. Namely, after forming several to several dozens of tracks on a separate plane by utilizing the servo plane, additional tracks are formed while preferably performing tracking based on the data in adjacent tracks on the same plane, as in Embodiment 1.

### Embodiment 3

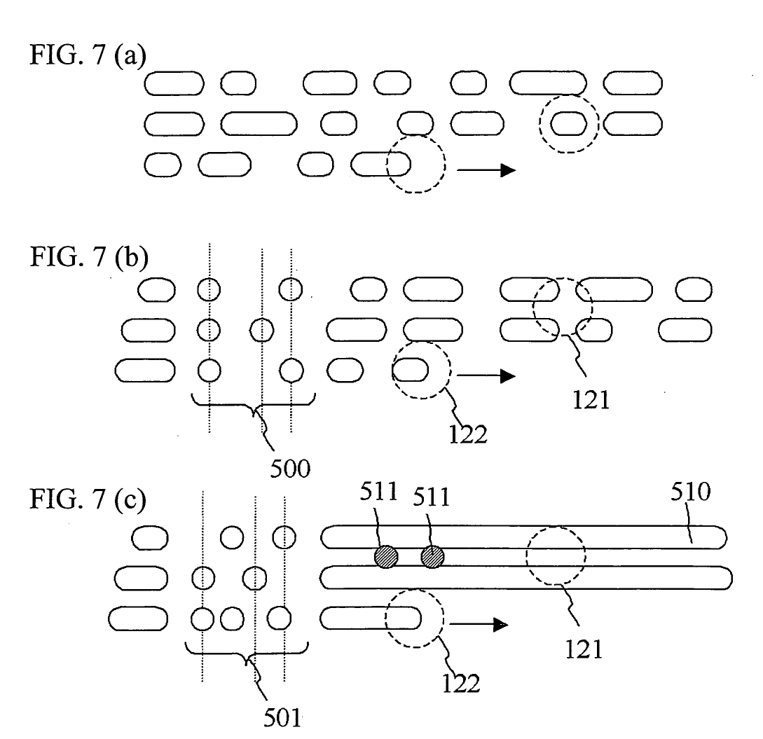

FIG. 7 shows an example of tracks formed in accordance with the present invention.

FIG. 7(a) shows a case where data is recorded in the form of a string of completely randomly modulated marks, as in CDs or DVD-ROMs, in which tracking is performed by DPD or the push-pull method. In this case, because data is recorded in the form of sector IDs in the address data mark string, for example, the first optical spot and the second optical spot must be each positioned at the center of a particular track. Thus, the spot intervals in the radius direction would be an integer multiple of the track pitch.

FIG. 7(b) shows another case where servo regions 500 aligned in the radial direction are allocated, in which tracking can be performed using a sample servo. The address information is read in the form of a gray code or CAPA (Complimentary Allocated Pit Address). Thus, the spot intervals of the first optical spot 121 would be a half-integer multiple of the track pitch.

FIG. 7(c) shows an example where a continuous groove tracking is performed. In this case, two methods can be employed. Namely, in a first method, a continuous groove 510 and an address portion 501 are formed by a leading spot (second spot 212), and thereafter, the trailing spot (first spot 211) is used for forming a mark 511. In a second method, the continuous groove 510 and the address portion 501 are formed by the leading spot (second spot 212) and a formatting is performed, followed by the recording of data in the form of the mark 511. In the case of the first method, although it is required that both optical spots can be modulated independently, formatting and recording can be performed simultaneously. In the case of the second method, recording can be performed solely with the leading spot, so that the aforementioned method whereby the intensity ratio of leading spot and trailing spot is fixed by the diffraction grating can be adopted. In the second method, there is a degree of freedom for the apparatus manufacturer to choose the same formatting depending on the apparatus cost and application. In this case, the address portion 501 may simply employ CAPA.

### Embodiment 4

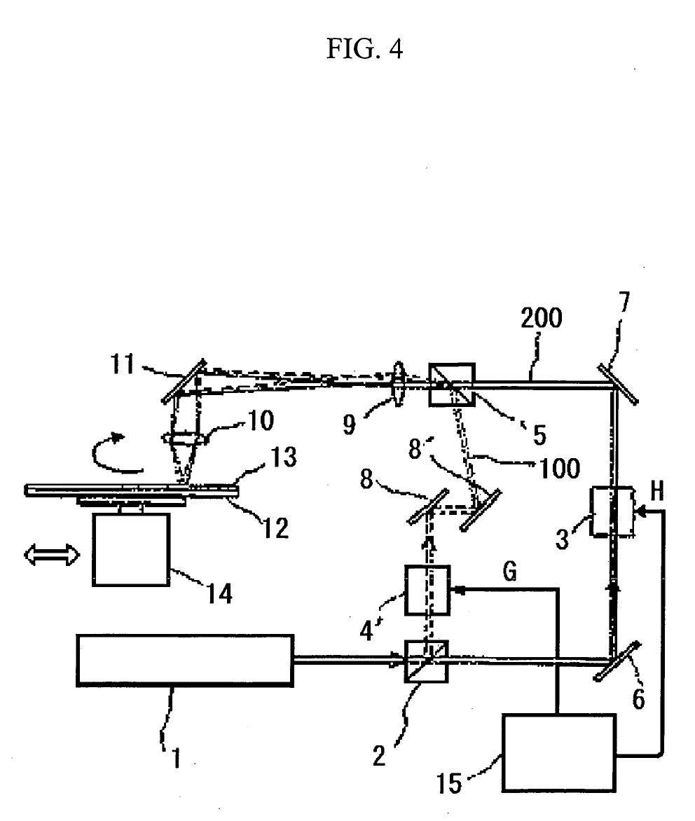

In the present embodiment, methods of pre-writing are described. In a first method, the medium is preformatted using an apparatus similar to the conventional, so-called cutting machine shown in FIG. 4 at the factory, for example, prior to shipping. In this case, only several to several dozens of tracks are preformatted per disc, so that each disc requires several seconds for processing, and the increase in cost by introducing the machine into the production line would be minimum. In another method, the prewriting is performed on the drive on the user's end.

This method requires a mechanism for dynamically adjusting the intervals of the two spots in the radial direction (such as a diffraction grating rotating mechanism). In a first step, a complete track is formed using only the leading spot without tracking. In a second step, the thus formed concentric track is tracked using the first spot (trailing spot), while controlling the radial distance between the first spot and second spot to be increased by the track pitch, in synchronism with the single rotation of the disc. By so doing, a complete spiral track can be formed. In this case, the first spot and the second spot are spaced apart by more than one track. Furthermore, since there is the possibility that the initial concentric track cannot be formed properly due to vibrations or the like, the quality of the track is preferably checked by way of the tracking signal quality after the formation of the track.

In the case of concentric tracks, instead of spiral tracks, although tracks can be formed by jumping from one complete concentric track to another without utilizing the spot interval adjusting capability, such a process is not suitable for continuous or high-speed recording because it would result in overhead costs for the track-jumping procedure.

### Embodiment 5

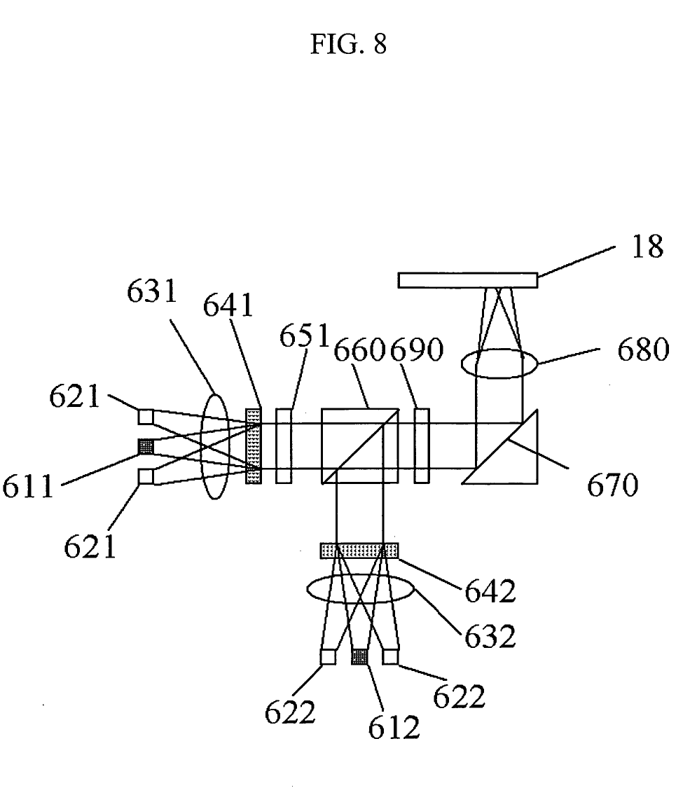

In the present embodiment, tracks are formed using two beams from two independent laser light sources. FIG. 8 shows an optical system equipped with the relevant capability. The disc is irradiated with two beams, namely, left-hand and right-hand circularly polarized light. Two semiconductor laser light sources 611 and 612 emit linearly polarized light beams, which are passed through diffraction gratings 641 and 642. One of the beams has its plane of polarization rotated by 90° by a ½ wavelength plate 651. The two beams of light are composed into a substantially single luminous flux by a polarizing beam splitter (PBS) 66. The polarizing beam splitter (PBS) 66 has a property such that it reflects the light with the polarization direction of laser 612 while letting through the light with the polarization direction that has been rotated by the wavelength plate 651. By “substantially single” above is meant that the angles of the two luminous fluxes are slightly different. When the composed light is converted into circularly polarized light by a ¼ wavelength plate 69, because the polarized planes of the light coming from the light source 611 and that from the light source 612 are perpendicular to each other, they are converted into different, namely, left and right, circularly polarized light. The light is shone on the medium 18 via a foldup mirror 67 and an objective lens 68, thereby forming two circularly polarized light spots. These circularly polarized light spots are slightly displaced by the aforementioned slight angular difference. Even where they are superposed, their polarization states are different, such that there is no possibility that the spot shapes might be deformed by interference. Thus, the distance between the spots can be determined arbitrarily. When reflected by the recording medium 18, the right-circularly polarized light is converted into left-circularly polarized light, while the left-polarized light is converted into right-polarized light by the mirror effect. Thus, once the reflected light passes through the ¼ wavelength plate 69, its polarization is perpendicular to the original polarization. As a result, the light is caused by the polarizing beam splitter (PBS) to travel back in a different direction from the original direction of the light source. The returning light is then guided by the diffraction gratings to the multi-segment detectors 621 and 622, from which servo signals for auto-focusing or tracking, as well as a read signal and push-pull signal, are produced. In the present embodiment, the positional relationship between the two spots was adjusted at a position that is slightly rotated from the original position of the ¼ wavelength plate 9. In this way, the return light beams can be caused to be incident on the same detector without being completely separated. Thus, by adjusting the position of the beams on the detector, the two beams can be accurately positioned. In practice, the amount of displacement of the two spots can be calculated from the amplitude of a push-pull signal that is obtained when the two beams are turned on and off alternately on a push-pull detector. This technique was adopted in the present embodiment for automatic adjustment purposes.

In the present embodiment, the light source consists of two semiconductor lasers with a wavelength of 405 nm. Light emitted by the light source is focused by an objective lens with the aperture ratio (NA) of 0.85 on the recording medium, thereby forming two adjacent optical spots thereon, each spot measuring approximately 450 nm in diameter.

1. A track forming method for an optical recording medium, comprising irradiating a disc-shaped optical recording medium with a first optical spot and a second optical spot, and forming a tracking mark or a guide groove using said second spot while performing a tracking using said first optical spot.

2. The track forming method for an optical recording medium according to claim 1, wherein the same recording surface is irradiated with said first optical spot and said second optical spot, and wherein the distance between said first spot and said second spot in the radial direction of the disc is substantially equal to an integer multiple or a half-integer multiple of the track pitch.

3. The track forming method for an optical recording medium according to claim 2, wherein said tracking mark or said guide groove is formed on the recording surface of said medium in advance, making at least one complete circle.

4. The track forming method for an optical recording medium according to claim 1, wherein said medium comprises a plurality of recording surfaces, wherein different recording surfaces are irradiated with said first optical spot and said second optical spot.

5. The track forming method for an optical recording medium according to claim 4, wherein said tracking mark or said guide groove is formed only on one of said plurality of recording surfaces in advance.

6. The track forming method for an optical recording medium according to claim 1, wherein address data is recorded simultaneously with the formation of said tracking mark or said guide groove.

7. The track forming method for an optical recording medium according to claim 1, wherein user data is recorded simultaneously with the formation of said racking mark or said guide groove.

8. The track forming method for an optical recording medium according to claim 1, wherein the intensity of said first optical spot is smaller than that of said second optical spot.

9. The track forming method for an optical recording medium according to claim 1, wherein said first optical spot and said second optical spot are formed using a diffraction grating.

10. The track forming method for an optical recording medium according to claim 1, wherein said first optical spot is emitted by a first light source and said second optical spot is emitted by a second light source.

11. A track forming method for an information recording medium, comprising forming a spiral or concentric track making at least one complete circle in advance, and then forming the remaining tracks using the earlier-formed tracks for tracking purposes.

12. A method of recording information, comprising irradiating a disc-shaped optical recording medium with a first optical spot and a second optical spot, and forming an information mark using said second spot while performing a tracking using said first optical spot.

13. The information recording method according to claim 12, wherein said information mark comprises user data.
